(19) United States
(12) Patent Application Publication
(10) Pub. No.: US 2004/0088682 A1
(43) Pub. Date: May 6, 2004

(54) Method, program product, and apparatus for cache entry tracking, collision detection, and address reasignment in processor testcases

(76) Inventors: Ryan C. Thompson, Ft. Collins, CO (US); John W. Maly, LaPorts, CO (US)

Correspondence Address: HEWLETT-PACKARD COMPANY, Intellectual Property Administration, P.O. Box 272400, Fort Collins, CO, 80527-2400, US

(21) Appl. No.: 10/288,034

(22) Filed: Nov. 5, 2002

(51) Int. Cl. G06F 9/44; G06F 19/00; G06F 17/50; H02H 3/05

(52) U.S. Cl. 717/124; 700/121; 703/14; 714/30

(57) ABSTRACT

A method and apparatus for converting a testcase written for a first member of a processor family to run on a second member of a processor family. The first and second members of the processor family have cache memory used by the testcase. The method includes steps of reading the testcase into a digital computer and searching for, and tabulating, cache initialization commands of the testcase. Tabulated cache initializations are then sorted by cache line address and way number and displayed. This information is used to determine whether the testcase will fit on the second member without modification, and to assist in making modifications to the testcase.

### RELATED APPLICATIONS

The present application is related to the material of previously filed U.S. patent application Ser. No. 10/163,859, filed Jun. 4, 2002.

### FIELD OF THE INVENTION

The invention relates to the fields of Computer-Aided Design (CAD), and test code for design and test of digital computer processor circuits. The invention particularly relates to CAD utilities for converting existing testcases to operate on new members of a processor family. The invention specifically relates to conversion of testcases having cache initialization.

### BACKGROUND OF THE INVENTION

The computer processor, microprocessor, and microcontroller industries are evolving rapidly. Many processor integrated circuits marketed in 2002 have ten or more times the performance of the processors of 1992. It is therefore necessary for manufacturers to continually design new products if they are to continue producing competitive devices.

### Testcases

When a design for a new processor integrated circuit is prepared, it is necessary to verify that the design is correct by a process called design verification. It is known that design verification can be an expensive and time-consuming process. It is also known that design errors not found during design verification can not only be embarrassing when they are ultimately discovered, but provoke enormously expensive product recalls.

Design verification typically requires development of many test codes. These test codes are generally expensive to develop. Each test code is then run on a computer simulation of the new design. Each difference between the computer simulation of a test code and expected results is analyzed to determine whether there is an error in the design, in the test code, in the simulation, or in several of these. Analysis is also expensive as it is often performed manually.

Typically; the test codes are constructed in a modular manner. Each code has one or more modules, each intended to exercise one or more particular functional units in a particular way. Each test code incidentally uses additional functional units. For example, a test code intended to exercise a floating point processing pipeline in a full-chip simulation will also use instruction decoding and memory interface, including cache memory and translation lookaside buffer functional units. Similarly, a test code intended to exercise integer execution units will also make use of memory interface functional units.

The simulation of the new design on which each test code is run may include simulation of additional “off-chip” circuitry. For example, this off-chip circuitry may include system memory. Off-chip circuitry for exercising serial ports may include loopback multiplexers for coupling serial outputs to serial inputs, as well as serializer and deserializer units.

The combination of test code with configuration and setup information for configuring the simulation model is a testcase.

It is known that testcases should be self-checking; as they must often be run multiple times during development of a design. Each testcase typically includes error-checking information to verify correct execution.

Once a processor design has been fabricated, testcases are often re-executed on the integrated circuits. Selected testcases may be logged and incorporated into production test programs.

### Memory Hierarchy

Modem high-performance processors implement a memory hierarchy having several levels of memory. Each level typically has different characteristics, with lower levels typically smaller and faster than higher levels.

A cache memory is typically a lower level of a memory hierarchy. There are often several levels of cache memory, one or more of which are typically located on the processor integrated circuit. Cache memory is typically equipped with mapping hardware for establishing a correspondence between cache memory locations and locations in higher levels of the memory hierarchy. The mapping hardware typically provides for automatic replacement (or eviction) of old cache contents with newly referenced locations fetched from higher-level members of the memory hierarchy. This mapping hardware often makes use of a cache tag memory. For purposes of this application cache mapping hardware will be referred to as a tag subsystem.

Many programs access data in memory locations that have either been recently accessed, or are located near recently accessed locations. This data may be loaded in fast cache memoryso that it is more quickly accessed than in main memory or other locations. For these reasons, it is known that cache memory often provides significant performance advantages.

When a cache memory is accessed, the cache system typically maps a physical memory address into a cache tag address through a hash algorithm. The hash algorithm is often as simple as selecting particular bits of the physical memory address to form the cache tag address. At each cache tag address, there are typically multiple cache tags, each cache tag being associated with a cache line. Each cache line is capable of storing data.

Many cache systems have several ways of associativity. Each way is associated with one cache tag at each cache tag address. A cache having four cache tags at each cache tag address typically has four ways of associativity.

A cache hit occurs when a cache memory system is accessed with a particular physical memory address and the cache tag at the associated cache tag address indicates that data associated with the physical memory address is in the cache. A cache miss occurs when a cache memory system is accessed and no data associated with the physical memory address is found in the cache.

Most modem computer systems implement virtual memory. Virtual memory provides one or more large, continuous, “virtual” address spaces to each of one or more executing processes on the machine. Address mapping circuitry is typically provided to translate virtual addresses, which are used by the processes to access locations in “virtual” address spaces, to physical memory locations in the memory hierarchy of the machine. Typically, each large, continuous, virtual address space is mapped to one or more, potentially discontinuous pages in a single physical memory address space. This address mapping circuitry often incorporates a translation lookaside buffer (TLB).

A TLB typically has multiple locations, where each location is capable of mapping a page, or other portion, of a virtual address space to a corresponding portion of a physical memory address space.

### New Processor Designs

Many new processor integrated circuit designs have similarities to earlier designs. New processor designs are often designed to execute the same, or a superset of, an instruction set of an earlier processor. For example, and not by way of limitation, some designs may differ significantly from previous designs in memory interface circuitry, but have similar floating point execution pipelines and integer execution pipelines. Other new designs may provide additional execution pipelines to allow a greater degree of execution parallelism than previous designs. Yet others may differ by providing for multiple threads or providing multiple processor cores in different numbers or manner than their predecessors; multiple processor or multiple thread integrated circuits may share one or more levels of a memory hierarchy between threads. Still others may differ primarily in the configuration of on-chip I/O circuitry.

Many manufactures of computer processor, microprocessor, and microcontroller devices have a library of existing testcases originally written for verification of past processor designs.

It is desirable to re-use existing testcases from a library of existing testcases in design verification of a new design. These libraries may be extensive, representing an investment of many thousands of man-hours. It is known, however, that some existing testcases may not be compatible with each new processor design.

Adaptation of existing testcases to new processor designs has largely been a manual task. Skilled engineers have reviewed documentation and interviewed test code authors to determine implicit assumptions and other requirements of the testcases. They have then made changes manually, tried the modified code on simulations of the new designs, and analyzed results. This has, at times, proved expensive.

### Adapting Testcases

It is desirable to automate the process of screening and adapting existing testcases to new processor designs.

In a computer system during normal operation, cache entries are dynamically managed. Typically, when a cache miss occurs, data is fetched from higher level memory into the cache. If data is fetched to a cache line already having data, that data will be evicted from the cache; resulting in a miss should the evicted data be referenced again. When data is fetched from higher level memory a possibility exists that processors requiring the data may be forced to “stall” or wait for the data to become available.

It is known that testcases may be sensitive to stalls, including stalls induced by cache misses, since stalls alter execution timing. Testcases may also have access, through special test modes, to registers, cache, and TLB locations. Simulation testcases may also directly initialize registers, cache and TLB locations.

Some testcases, including but not limited to testcases that test for interactions between successive operations in pipelines, are particularly sensitive to execution timing. These testcases may include particular cache entries as part of their setup information for simulation. Similarly, testcases intended to exercise memory mapping hardware, including a TLB, or intended to exercise cache functions, may also require particular cache entries as part of their setup information.

It is also desirable to avoid disturbing execution timing of testcases that rely on dynamic cache management when these testcases are run on a new processor design.

It is desirable to ensure that all locations intended to reside in cache of the original architecture reside in cache on new processor designs.

It is known that memory hierarchy elements, such as cache, on a processor circuit often consume more than half of the circuit area. It is also known that some applications require more of these elements than others. There are often competitive pressures to proliferate a processor family down to less expensive integrated circuits having less cache, and upwards to more expensive integrated circuits having multiple processors and/or larger cache. A new processor design may therefore provide a different cache size or organization than an original member of a processor family, or provide for sharing of one or more levels of cache by more than one instruction stream.

### Screening And Converting Testcases

In a particular library of existing testcases there are testcases each containing cache initialization entries. In this particular library, there are also several testcases that rely on automatic cache management although it is desirable to ensure that their execution times are not altered.

A particular new processor design has at least one processor, and may have multiple processor cores, on a single integrated circuit. This circuit has a memory hierarchy having portions, including cache, that may be shared between processors.

It is desired to screen the existing library to determine which testcases will run on this new design without conversion, and to convert remaining testcases so that they may run properly on the new design.

Further, each processor core of the new design should be tested. Testing complex processor integrated circuits can consume considerable time on very expensive test systems. It is therefore particularly desirable to execute multiple testcases simultaneously, such that as many processor cores as reasonably possible execute testcases simultaneously.

When multiple testcases, each using a shared resource, are simultaneously executed on a multiple-core integrated circuit it is necessary to eliminate resource conflicts between them. For example, if a cache location is initialized by a first testcase, and altered by another testcase before the first testcase finishes, the first testcase may behave in an unexpected manner by stalling to fetch data from higher levels of memory. If a cache is shared among multiple processor cores, it is advisable to allocate specific cache locations to particular testcases.

### Summary

A method and computer program product is provided for automatically screening testcases originally prepared for a previous processor design for compatibility with a new processor design having differences in memory hierarchy or processor count than the previous processor. The method and computer program product is capable of extracting cache setup information and probable cache usage from a testcase and displaying it. The cache setup information is tabulated by cache line address and way number before it is displayed.

In a second level of automatic testcase conversion, the method and computer program product is capable of limited remapping of cache usage to allow certain otherwise-incompatible, preexisting, testcases to execute correctly on the new processor design.

The method is particularly applicable to testcases having cache entries as part of their setup information. The method is applicable to new processor designs having cache shared among multiple threads or processors, or new designs having smaller cache, than the processors for which the testcases were originally developed.

The method operates by reading setup and testcode information from one or more testcases. Cache entry usage and initialization information is then extracted from the testcase.

In a particular embodiment having a first level of automated screening and conversion, cache entries initialized and used by a testcase are verified against those available in a standard partition on a new architecture. If all cache entries initialized or used fit in the partition, the testcase is marked runable on the new architecture, and outputted.

Remaining testcases are flagged as requiring conversion. Cache initializations are tabulated, mapped, and displayed for these testcases to assist with manual or automatic conversion. Cache usage is also predicted from memory usage, using known relationships of memory addresses to cache line addresses. The predicted cache usage is also tabulated, mapped, and displayed to assist with manual conversion.

In an alternative embodiment, cache and usage predicted from memory usage is tabulated, mapped, and displayed even if the testcase fits in the standard partition.

In a particular embodiment having a second level of automated screening and conversion, cache entries initialized and used by a testcase are verified against those available in an enlarged partition on the new architecture. If all cache entries initialized or used fit in the partition, the testcase is marked runable on the enlarged partition of the new architecture, and outputted with the tabulated predicted cache usage.

### BRIEF DESCRIPTION OF THE DRAWINGS

FIG. 1 is an illustration of cache of small and large members of a processor family;

FIG. 2, a first part of a flowchart of an automatic testcase screening and conversion utility;

FIG. 3, a second part of a flowchart of an automatic testcase screening and conversion utility; and

FIG. 4, apparatus for screening and converting testcases by executing the herein-described method.

### DETAILED DESCRIPTION

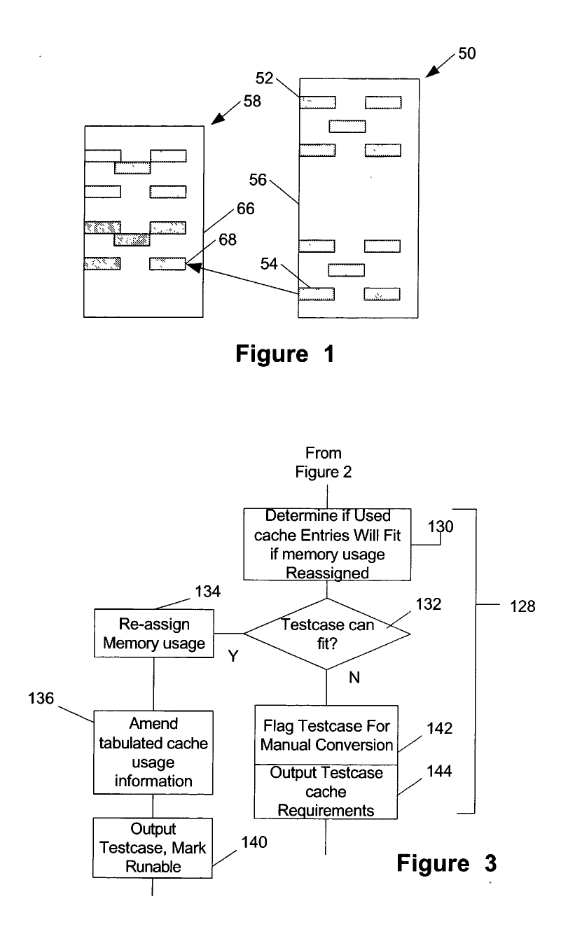

A testcase, intended to be executed on either a simulation or actual hardware of a processor integrated circuit, is extracted from a library of pre-existing testcases and read into a computer. The testcase is designed to use particular locations 52, 54 (FIG. 1) in a cache 50. There may also be unused locations 56 in the cache.

A new processor integrated circuit architecture also having cache is defined. This architecture provides a cache 58 that may, but need not, be the same size as the original cache 50. The new processor may alternatively share a cache the same or larger size than the original cache 50 among multiple processor cores.

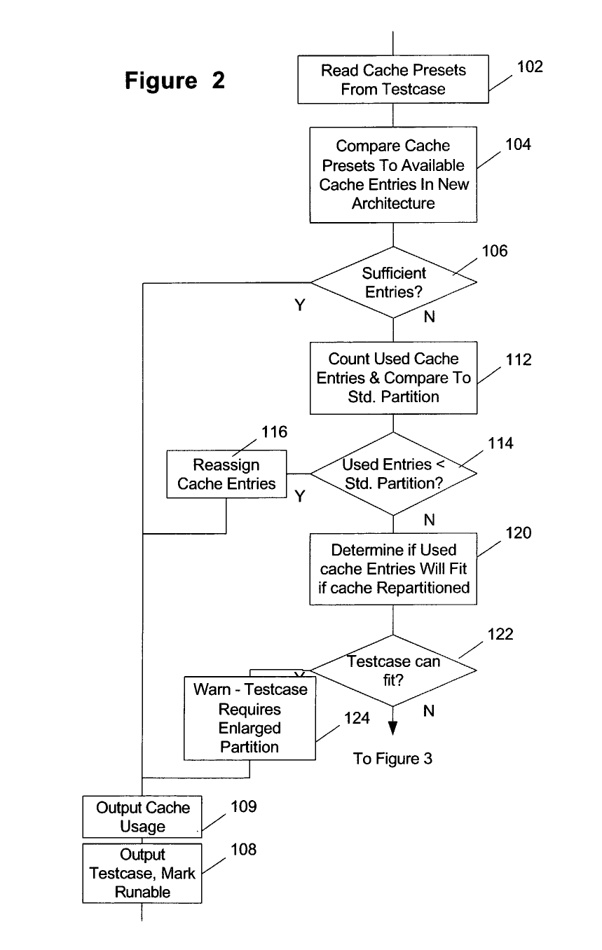

The method 100 (FIGS. 2 & 3) begins by reading 102 cache presets from each testcase. These presets are tabulated and compared 104 with locations actually present in a standard partition of the new architecture. Testcases for which all preset locations are present in a standard partition are marked runable as-is 108 on the new architecture, and outputted. Also outputted 109 are expected cache utilization, based upon cache initializations, memory usage, and known relationships of memory addresses to cache line addresses.

For those testcases that will not fit without modification, tabulated cache presets and predicted usage are counted 112 and compared 114 with the available entries in the standard partition of the new architecture. If the preset and used locations can be reassigned to entries that fit in the standard partition, these entries are reassigned 116.

The process of reassigning 116 entries is performed by using known relationships between cache locations and higher-level memory locations to associate preset cache entries to symbols defined in the test code and used in instructions that access data from these cache locations. These relationships are determined by the hash algorithms that are used to map memory locations to cache locations. Preset cache entries are then reassigned to available locations, and associated symbols redefined such that data stored in the cache entries will be correctly referenced by the instructions.

In a particular embodiment, testcases that would not fit in the standard partition of the new architecture are examined 120 to determine if 122 they will fit in a larger partition. The larger partition may be a partition available when one or more processors of the processor integrated circuit is shut down. In the event that the testcase fits in the enlarged partition, a warning message is outputted 124 before outputting 109 cache utilization and outputting 108 the testcase.

In a particular embodiment having a further level of automated conversion 128, testcases where all cache entries initialized or used would not fit in the larger partition are examined 130 to determine if shifting some memory usage would allow the test case to fit. In this event, memory usage is reassigned 134 in a copy of the testcase, the tabulated cache usage information for the testcase is copied, amended to correspond with the reassigned memory usage, marked runable on the enlarged partition of the new architecture, and outputted 140 with the tabulated predicted cache usage. The original testcase is also outputted with its tabulated cache utilization.

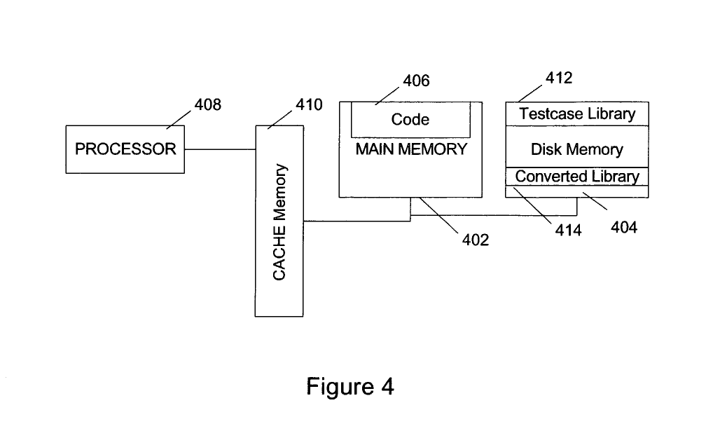

A computer program product is any machine-readable media, such as an EPROM, ROM, RAM, DRAM, disk memory, or tape, having recorded on it computer readable code that, when read by and executed on a computer, instructs that computer to perform a particular function or sequence of functions. A computer, such as the apparatus of FIG. 4, having the code loaded or executing on it is generally a computer program product because it incorporates RAM main memory 402 and/or disk memory 404 having the code 406 recorded in it.

Apparatus (FIG. 4) for converting a testcase incorporates a processor 408 with one or more levels of cache memory 410. The processor 408 and cache 410 are coupled to a main memory 402 having program code 406 recorded therein for executing the method as heretofore described with reference to FIGS. 2 and 3, as well as sufficient working space for converting testcases. The processor 408 and cache 410 are coupled to a disk memory 404 having a testcase library 412 recorded in it. The apparatus operates through executing the program code 406 to read testcases from the testcase library 412, converting them, and writing the converted testcases into a converted library 414 in the disk memory 404 system.

What is claimed is:

1. A method of converting a testcase designed to execute on a first member of a processor family to a converted testcase for execution on a second member of the processor family, where both the first and second members of the processor family have cache and where the testcase uses a plurality of locations within cache, the method comprising the steps of:
reading the testcase into a digital computer,
searching the testcase for cache initialization commands, and tabulating the cache initialization commands from the testcase;
sorting the tabulated cache initialization commands by cache line address and way number, and displaying the tabulated cache usage.

2. The method of claim 1, further comprising the steps of examining memory usage of the testcase, predicting cache usage associated with the memory usage, and adding predicted cache usage associated with memory usage to the tabulated cache usage.

3. The method of claim 2, further comprising the steps of
comparing tabulated cache usage to cache available in a predetermined standard partition of the second member of the processor family; and
determining whether tabulated cache usage fits in the predetermined standard partition.

4. The method of claim 1, further comprising the steps of
comparing tabulated cache usage to cache available in a predetermined standard partition of the second member of the processor family; and
determining whether tabulated cache usage fits in the predetermined standard partition.

5. A computer program product comprising a machine readable media having recorded therein a sequence of instructions for converting a testcase, where the testcase is a testcase executable on a first member of a processor family, the sequence of instructions capable of generating a converted testcase for execution on a second member of the processor family, where both the first and second members of the processor family incorporate a cache and where the testcase uses a plurality of locations within the cache, the sequence of instructions comprising instructions for performing the steps:
reading the testcase into a digital computer,
searching the testcase for cache initialization commands, and tabulating the cache initialization commands from the testcase;
sorting the tabulated cache initialization commands by cache line address and way number, and displaying the tabulated cache usage.

6. The program product of claim 5, wherein the sequence of instructions further comprises instructions for performing the steps of examining memory usage of the testcase, predicting cache usage associated with the memory usage, and adding predicted cache usage associated with memory usage to the tabulated cache usage.

7. The program product of claim 6, wherein the sequence of instructions further comprises instructions for performing the steps of:
comparing tabulated cache usage to cache available in a predetermined standard partition of the second member of the processor family; and
determining whether tabulated cache usage fits in the predetermined standard partition.

8. The program product of claim 5, wherein the sequence of instructions further comprises instructions for performing the steps of:
comparing tabulated cache usage to cache available in a predetermined standard partition of the second member of the processor family; and
determining whether tabulated cache usage fits in the predetermined standard partition.

9. Apparatus for converting a testcase, the apparatus comprising a processor and a memory system having recorded therein a sequence of instructions for converting a testcase, where the testcase is a testcase executable on a first member of a processor family, the sequence of instructions capable of generating a converted testcase for execution on a second member of the processor family, where both the first and second members of the processor family incorporate a cache and where the testcase uses a plurality of locations within the cache, the sequence of instructions comprising instructions for performing the steps:
reading the testcase into a digital computer,
searching the testcase for cache initialization commands, and tabulating the cache initialization commands from the testcase;
sorting the tabulated cache initialization commands by cache line address and way number, and displaying the tabulated cache usage.

10. The apparatus of claim 9, wherein the sequence of instructions further comprises instructions for performing the steps of examining memory usage of the testcase, predicting cache usage associated with the memory usage, and adding predicted cache usage associated with memory usage to the tabulated cache usage.

11. The apparatus of claim 10, wherein the sequence of instructions further comprises instructions for performing the steps of:
comparing tabulated cache usage to cache available in a predetermined standard partition of the second member of the processor family; and
determining whether tabulated cache usage fits in the predetermined standard partition.

12. The apparatus of claim 9, wherein the sequence of instructions further comprises instructions for performing the steps of:
comparing tabulated cache usage to cache available in a predetermined standard partition of the second member of the processor family; and
determining whether tabulated cache usage fits in the predetermined standard partition.
